(19) United States
(12) Patent Application Publication
(10) Pub. No.: US 2026/0270955 A1
(43) Pub. Date: Sep. 10, 2026

(54) CHANNEL CONFIGURATION BASED ON LOGICAL CHANNEL CONDITIONS

(71) Applicant: Lenovo (Singapore) Pte. Limited, Singapore (SG)

(72) Inventors: Joachim Löhr, Wiesbaden (DE); Alexander Golitschek Edler von Elbwart, Darmstadt (DE); Karthikeyan Ganesan, Kronberg Im Taunus (DE); Prateek Basu Mallick, Dreieich (DE)

(73) Assignee: Lenovo (Singapore) Pte. Limited, Singapore (SG)

(21) Appl. No.: 18/881,429

(22) PCT Filed: Jun. 27, 2023
(86) PCT No.: PCT/IB2023/056589

§ 371 Date: Jan. 6, 2025

Related U.S. Application Data
(60) Provisional application No. 63/358,631, filed on Jul. 6, 2022.

(51) Int. Cl. H04W 72/02; H04L 1/1812; H04W 74/0808

(52) U.S. Cl. CPC H04W 72/02; H04L 1/1812; H04W 74/0808

(57) ABSTRACT

Various aspects of the present disclosure relate to methods, apparatuses, and systems that support channel configuration based on logical channel conditions. For instance, different logical channel conditions are utilized to configure wireless channels for data transmissions, e.g., PSSCH allocations such as for sidelink transmissions. According to implementations a UE applies a first logical channel condition for a first PSSCH allocation of a set of consecutive PSSCH allocations and second logical channel conditions for remaining PSSCH allocations. The second logical channel conditions, for example, specify certain conditions for high priority data to be mapped to a subsequent PSSCH allocation.

### RELATED APPLICATION

This application claims priority to U.S. Patent Application Ser. No. 63/358,631 filed 6 Jul. 2022 entitled “CHANNEL CONFIGURATION BASED ON LOGICAL CHANNEL CONDITIONS,” the disclosure of which is incorporated by reference herein in its entirety.

### TECHNICAL FIELD

The present disclosure relates to wireless communications, and more specifically to wireless channel configuration.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for configuring wireless channels for data transmission, such as for physical sidelink shared channel (PSSCH) configuration. However, some techniques apply static data configurations for wireless channels that may not be adaptable to certain failures related to channel conditions.

### SUMMARY

The present disclosure relates to methods, apparatuses, and systems that support channel configuration based on logical channel conditions. For instance, different logical channel conditions are utilized to configure wireless channels for data transmissions, e.g., PSSCH allocations such as for sidelink transmissions. According to implementations a UE applies a first logical channel condition for a first PSSCH allocation of a set of consecutive PSSCH allocations. The first PSSCH allocation, for example, immediately follows a clear channel assessment (CCA) procedure, e.g., a listen before talk (LBT) procedure. The first logical channel condition, for instance, specifies that high priority data is not to be mapped to the first PSSCH allocation of the set of consecutive PSSCH allocations. Further, the high priority data can be mapped to a subsequent PSSCH allocation of the set of consecutive PSSCH allocations which fulfils certain second logical channel conditions, such as by applying the second logical channel conditions for remaining PSSCH allocations. The second logical channel conditions, for example, specify certain conditions for high priority data to be mapped to a subsequent PSSCH allocation, such as that the subsequent PSSCH allocation does not include a physical sidelink feedback channel (PSFCH) or sidelink positioning reference signal (SL-PRS).

By utilizing the described techniques, delay and/or failure of transmission of high priority data can be reduced. The described techniques, for instance, can reduce latency that may occur in the wireless transmission of high priority data and increase reliability in data transmission.

Some implementations of the method and apparatuses described herein may further include generating, for a set of PSSCH allocations and based at least in part on a first logical channel condition associated with logical channel prioritization, a first set of media access control (MAC) protocol data units (PDU) for a first subset of PSSCH allocations of the set of PSSCH allocations; and generating, for the set of PSSCH allocations and based at least in part on a second logical channel condition associated with logical channel prioritization, a second set of MAC PDUs for a second subset of PSSCH allocations of the set of PSSCH allocations.

Some implementations of the method and apparatuses described herein may further include determining the set of PSSCH allocations based on at least one predefined criterion; where the at least one predefined criterion includes that the second subset of PSSCH allocations do not include a PSFCH; where the at least one predefined criterion includes that the second subset of PSSCH allocations do not include a sidelink PRS; where the first subset of PSSCH allocations starts with a first PSSCH allocation of the set of PSSCH allocations; performing a listen before talk procedure before the first subset of PSSCH allocations; preventing, as part of the logical channel prioritization, mapping of high priority data to the first subset of PSSCH allocations; where the first logical channel condition is different than the second logical channel condition; where the set of PSSCH allocations includes consecutive PSSCH allocations; where the first logical channel condition includes that data below a threshold priority is mapped to the first subset of PSSCH allocations.

Some implementations of the method and apparatuses described herein may further include where the first logical channel condition includes that data above a threshold priority is not mapped to the first subset of PSSCH allocations; where the second logical channel condition includes an indication that data above a threshold priority is mapped to the second subset of PSSCH allocations; where the second logical channel condition includes that when data above a threshold priority is mapped to a PSSCH resource of the second subset of PSSCH allocations, one or more of: the PSSCH resource does not include a PSFCH; PSFCH timing is not delayed; the PSSCH resource does not include sidelink PRS; the PSSCH resource is within a discontinuous reception (DRX) time of a transmit destination UE; or a modulation and coding scheme (MCS) to be used for transmission over the PSSCH resource is not a specified level higher than an MCS previously selected for the PSSCH resource; further including transmitting data over one or more of the first set of MAC PDUs or the second set of MAC PDUs; further including transmitting data over one or more of the first subset of PSSCH allocations or the second subset of PSSCH allocations.

Some implementations of the method and apparatuses described herein may further include generating a notification that specifies, for a set of PSSCH allocations: a first logical channel condition associated with logical channel prioritization for a first subset of PSSCH allocations of the set of PSSCH allocations; and a second logical channel condition associated with logical channel prioritization for a second subset of PSSCH allocations of the set of PSSCH allocations; and transmitting the notification to a UE.

Some implementations of the method and apparatuses described herein may further include where the notification specifies that the first subset of PSSCH allocations is to start with a first PSSCH allocation of the set of PSSCH allocations; where the first logical channel condition is different than the second logical channel condition; where the first logical channel condition specifies that high priority data is not to be mapped to the first subset of PSSCH allocations; where the second logical channel condition includes an indication that data above a threshold priority is to be mapped to the second subset of PSSCH allocations; where the second logical channel condition includes that when data above a threshold priority is mapped to a PSSCH resource of the second subset of PSSCH allocations, one or more of: the PSSCH resource is not to include a PSFCH; PSFCH timing is not to be delayed; the PSSCH resource is not to include sidelink PRS; the PSSCH resource is to be within a DRX time of a transmit destination UE; or a MSC to be used for transmission over the PSSCH resource is not to be a specified level higher than an MCS previously selected for the PSSCH resource.

Some implementations of the method and apparatuses described herein may further include performing, by a UE, a listen before talk procedure on a first sidelink resource to be used for a sidelink transmission; selecting, autonomously by the UE and based at least in part on a failure of the listen before talk procedure, a second sidelink resource to be used for the sidelink transmission; and transmitting the sidelink transmission using the second sidelink resource.

Some implementations of the method and apparatuses described herein may further include receiving an indication of the failure of the listen before talk procedure from a physical layer (PHY); where the second sidelink resource includes a next slot after the first sidelink resource; selecting the second sidelink resource as a sidelink resource such that one or more of: the second sidelink resource does not include a PSFCH; PSFCH timing is not delayed by selection of the second sidelink resource; the second sidelink resource does not include sidelink PRS; the second sidelink resource is within a DRX time of a transmit destination UE; or a MSC to be used for transmission over the second sidelink resource is not a specified level higher than an MCS previously selected for the first sidelink resource; where the sidelink transmission on the first sidelink resource includes a transport block in a hybrid automatic repeat-request (HARQ) buffer, and that transmitting the sidelink transmission using the second sidelink resource includes a HARQ retransmission of the transport block; where the UE is configured with a maximum number of HARQ transmissions, and the UE is configured to exceed the maximum number with the HARQ retransmission of the transport block.

### BRIEF DESCRIPTION OF THE DRAWINGS

FIG. 1 illustrates an example of a wireless communications system that supports channel configuration based on logical channel conditions in accordance with aspects of the present disclosure.

FIG. 2 illustrates different channel occupancy times (COTs) and idle periods between the COTs.

FIG. 3 illustrates an implementation where different COT initiators are utilized for different physical uplink shared channel (PUSCH) transmissions and/or repetitions.

FIG. 4 illustrates an implementation where a UE initiates a COT.

FIG. 5 illustrates an implementation that supports channel configuration based on logical channel conditions in accordance with aspects of the present disclosure.

FIG. 6 illustrates an implementation that supports channel configuration based on logical channel conditions in accordance with aspects of the present disclosure.

FIG. 7 illustrates an example of a slot that supports channel configuration based on logical channel conditions in accordance with aspects of the present disclosure.

FIGS. 8 and 9 illustrate examples of block diagrams of devices that support channel configuration based on logical channel conditions in accordance with aspects of the present disclosure.

FIGS. 10 through 12 illustrate flowcharts of methods that support channel configuration based on logical channel conditions in accordance with aspects of the present disclosure.

### DETAILED DESCRIPTION

In some wireless communications systems, ways are provided for logical channel prioritization (LCP) where a UE multiplexes high priority data to a first PSSCH allocation in scenarios where the UE has a set of consecutive PSSCH allocations. However, when operating in a shared spectrum with multi-PSSCH allocations, a first SL allocation may have a highest probability of CCA failure where a UE is to perform CCA to initiate a sequence of sidelink transmissions. Therefore, mapping high priority data to a first PSSCH immediately following a CCA procedure may result in an increased delay for the transmission of the high priority data due to resulting HARQ retransmissions.

For example, in some wireless communications systems for scenarios that involve a multi-transmission time interval (TTI) grant, high priority data may be placed in a first transport block (TB) respectively and thus may be transmitted within the first PUSCH allocation. However, following this principle for a multi-TTI grant when operating in a shared spectrum may result in a situation where a UE is not able to transmit high priority data and/or a MAC control element (CE) due to CCA failure, and/or where part of the transmission is lost due to a later access to the channel such that the corresponding TB would not be decodable without further (e.g., later) retransmission. For example, a UE performs CCA to initiate a sequence of uplink (UL) transmissions within the multi-TTI grant, and the first UL grant is the most probable instance where UL transmission failure may occur due to CCA failure. Therefore, mapping high priority data in the first PUSCH immediately following a CCA procedure may result in an increased delay for the transmission of the high priority data due to necessary HARQ retransmissions.

Accordingly, this disclosure provides for techniques that support channel configuration based on logical channel conditions. For instance, different logical channel conditions are utilized to configure wireless channels for data transmissions, e.g., PSSCH allocations such as for sidelink transmissions. According to implementations a UE applies a first logical channel condition for a first PSSCH allocation of a set of consecutive PSSCH allocations. The first PSSCH allocation, for example, immediately follows a CCA procedure, e.g., an LBT procedure. The first logical channel condition, for instance, specifies that high priority data is not to be mapped to the first PSSCH allocation of the set of consecutive PSSCH allocations. Further, the high priority data can be mapped to a subsequent PSSCH allocation of the set of consecutive PSSCH allocations which fulfils certain second logical channel conditions, such as by applying the second logical channel conditions for remaining PSSCH allocations. The second logical channel conditions, for example, specify certain conditions for high priority data to be mapped to a subsequent PSSCH allocation, such as that the subsequent PSSCH allocation does not include a PSFCH or SL-PRS.

This disclosure also provides techniques to enable a UE to trigger selection of a new SL resources for cases when a SL transmission was not performed due to an CCA failure. For instance, a UE which is configured for the resource allocation Mode 2 selects a new additional SL resource for the transmission of a TB in response to receiving an CCA (e.g., LBT) failure indication from a PHY layer for the transmission attempt of a TB and/or PSSCH. A CCA failure event, for example, is used as a trigger for SL resource selection, e.g., reselection.

Thus, by utilizing the described techniques, the risk of delaying transmission of high priority data and/or MAC CEs due to a CCA failure is mitigated, such as may occur for CCA failures for a first PSSCH allocation of set of consecutive PSSCH allocations. Further, autonomous UE selection of sidelink resources in response to CCA failure reduces delays and signaling overhead in contrast with some conventional resource selection procedures. The described techniques can thus reduce data transmission latency and provide increased data transmission reliability, such as for the transmission of high priority data using sidelink resources.

Aspects of the present disclosure are described in the context of a wireless communications system. Aspects of the present disclosure are further illustrated and described with reference to device diagrams and flowcharts.

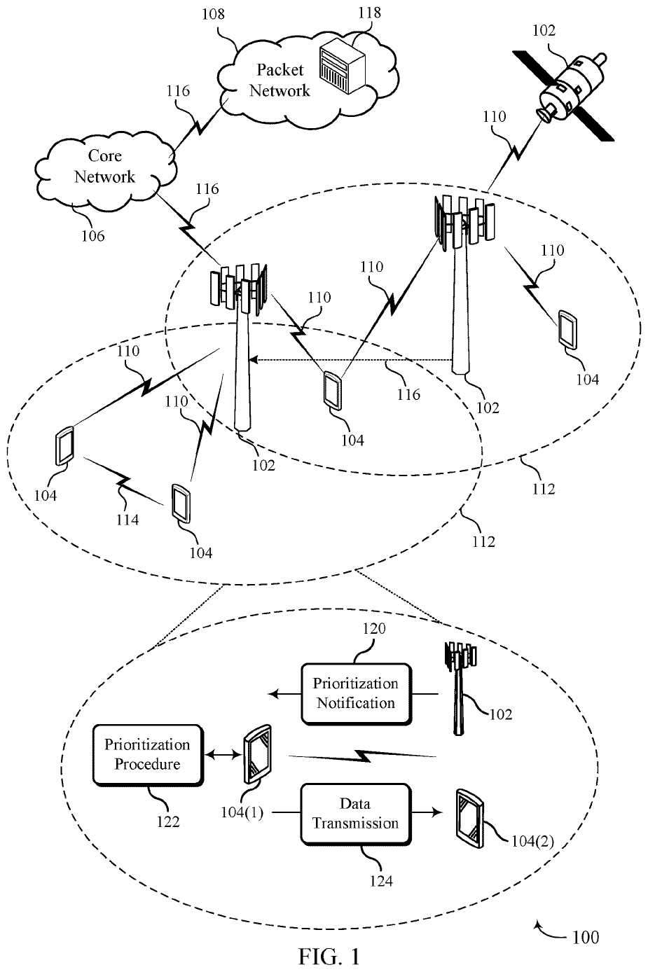

FIG. 1 illustrates an example of a wireless communications system 100 that supports channel configuration based on logical channel conditions in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., PHY layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=²) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for channel configuration based on logical channel conditions, a network entity 102 generates a prioritization notification 120 and transmits the prioritization notification 120 to a UE 104(1). The prioritization notification 120, for instance, includes various parameters for mapping data to sidelink resources used by the UE 104(1), such as for configuring PSSCH allocations utilized by the UE 104(1). For example, the prioritization notification 120 includes different logical channel conditions for performing LCP, such as based on different data priorities and/or data types. Examples of different logical channel conditions are described throughout this disclosure.

Accordingly, based at least in part on the prioritization notification 120, the UE 104(1) performs a prioritization procedure 122 for mapping data to wireless resources such as different subsets of PSSCH allocations for sidelink transmissions as part of COT sharing. As detailed herein, for instance, the prioritization procedure 122 maps high priority data to subsequent PSSCH allocations that occur after initial PSSCH allocations following a CCA procedure. Further, mapping of high priority data to the subsequent PSSCH allocations can be conditioned on certain logical channel conditions, examples of which are provided throughout this disclosure. Based at least in part on the prioritization procedure 122, the UE 104(1) performs data transmission 124 of mapped data using the PSSCH allocations as determined by the prioritization procedure 122. The data transmission 124, for instance, utilizes PSSCH allocations obtained as part of COT sharing with a different UE 104, such as with the UE 104(2) and/or other UE 104.

In some wireless communications systems, devices (e.g., UEs, network nodes (e.g., gNBs), etc.) may operate in unlicensed spectrum and may perform a CCA (e.g., by LBT and/or channel sensing) prior to being able to transmit in the unlicensed spectrum. If a device performing CCA does not detect the presence of other signals in a channel, the channel may be considered available for transmission. In a frame based equipment (FBE) mode of operation, a device can perform CCA in an idle period and when a channel is acquired, the device can communicate within a non-idle time of a fixed frame period duration, referred to as COT). In some current specifications and/or regulations, the idle time is not shorter than the maximum of 5% of a fixed frame period (FFP) and 100 microseconds.

Further, determination of ownership of a COT (e.g., which device has initiated the COT) at both a gNB and a UE for an UL transmission is used to determine:
1) Whether another UE can send another UL transmission within the COT.
2) Which idle period (gNB's or UE's) should be respected (e.g., an UL transmission is not allowed within the respected idle period).
3) Energy detection (ED) threshold (which might be different e.g., in case gNB shares UE-COT or UE-initiated COT or might be different if the ED threshold is determined based on UE transmit power, and/or gNB transmit power)

Further, in some wireless communications systems for cases when sidelink is operated on a cell configured with shared spectrum, the corresponding UE actions upon detection of CCA failures for sidelink transmission are not defined.

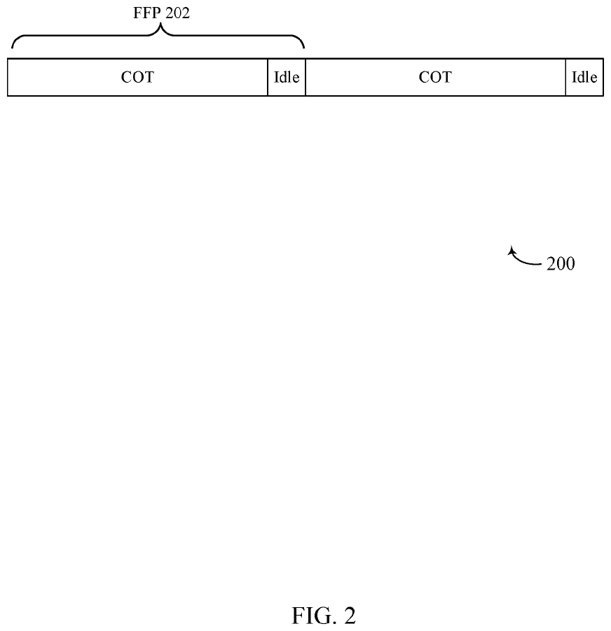

FIG. 2 illustrates at 200 different COTs and idle periods between the COTs. Further, an FFP 202 is illustrated that includes a particular COT and idle period.

A UE can perform channel sensing and access a channel if it senses the channel to be idle. UE initiated channel occupancy (CO) can be useful especially in low-latency applications, wherein having UL data to be sent in configured grant resources is allowed to initiate a CO.

A single downlink control information (DCI) may schedule several TBs, referred to as multi-PUSCH transmission. According to technical specification (TS) 38.214 V16.5.0:
If pusch-TimeDomainAllocationListForMultiPUSCH in pusch-Config contains row indicating resource allocation for two to eight contiguous PUSCHs, K2 indicates the slot where UE shall transmit the first PUSCH of the multiple PUSCHs. Each PUSCH has a separate start and length indicator value (SLIV) and mapping type.
The number of scheduled PUSCHs is signalled by the number of indicated valid SLIVs in the row of the pusch-TimeDomainAllocationListForMultiPUSCH signalled in DCI format 0_1.

For COT initiator determination for configured grant (CG) transmissions, it has been specified that:
When a configured UL transmission starts after a UE FFP boundary and ends before the idle period of that UE FFP associated to the UE:
   If the UE has already initiated the UE FFP, then UE assumes that the configured UL transmission corresponds to UE-initiated COT

Otherwise, if the transmission is confined within a gNB FFP before the idle period of that gNB FFP, and if the UE has already determined that gNB has initiated that gNB FFP, then UE can assume that the configured UL transmission corresponds to gNB-initiated COT.

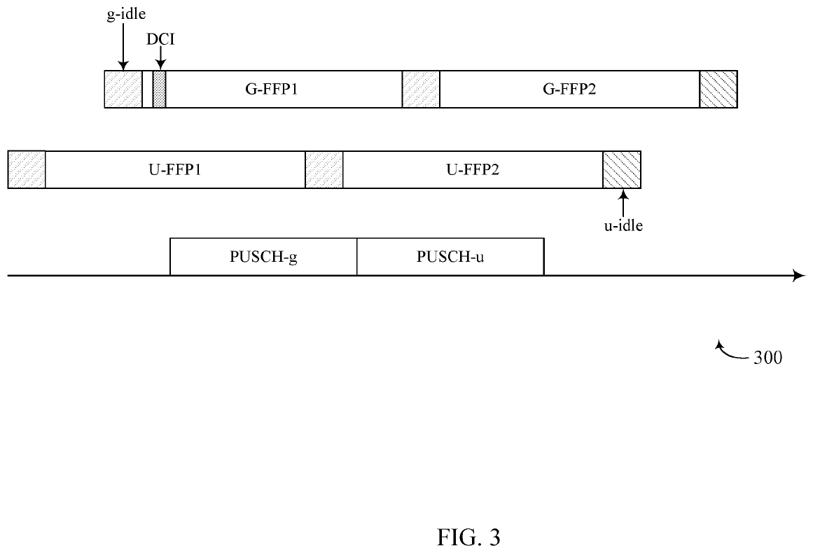

FIG. 3 illustrates an implementation 300 where different COT initiators are utilized for different PUSCH transmissions and/or repetitions. In the implementation 300, u-FFP refers to a UE-FFP (FFP associated and/or configured for UE-initiated COT), g-FFP refers to a gNB-FFP (FFP associated and/or configured for gNB-initiated COT), PUSCH-g refers to a PUSCH transmission that is sent based on a gNB being a COT initiator, and PUSCH-u refers to a PUSCH transmission that is sent based on a UE being a COT initiator.

Further at 300, the DCI schedules PUSCH-g and PUSCH-u. A gNB has initiated a COT in G-FFP1 (e.g., to serve other UEs or to schedule a UE). A UE has not initiated a COT in U-FFP1. PUSCH-g is not aligned with a u-FFP boundary and transmitted based on gNB as COT initiator. PUSCH-u can be sent during g-idle (if COT initiator for PUSCH-u is indicated to be the UE) as gNB does not have any other data to initiate a g-COT in G-FFP2. Further, g-idle maybe longer than u-idle and/or the overlap with g-idle and PUSCH-u may also be longer than the overlap of PUSCH-g and u-idle. An LBT/gap may be implemented between PUSCH-g and PUSCH-u of the UE, e.g., where PUSCH-g ends and/or PUSCH-g symbols overlapping with u-idle are considered as invalid symbols prior to u-idle.

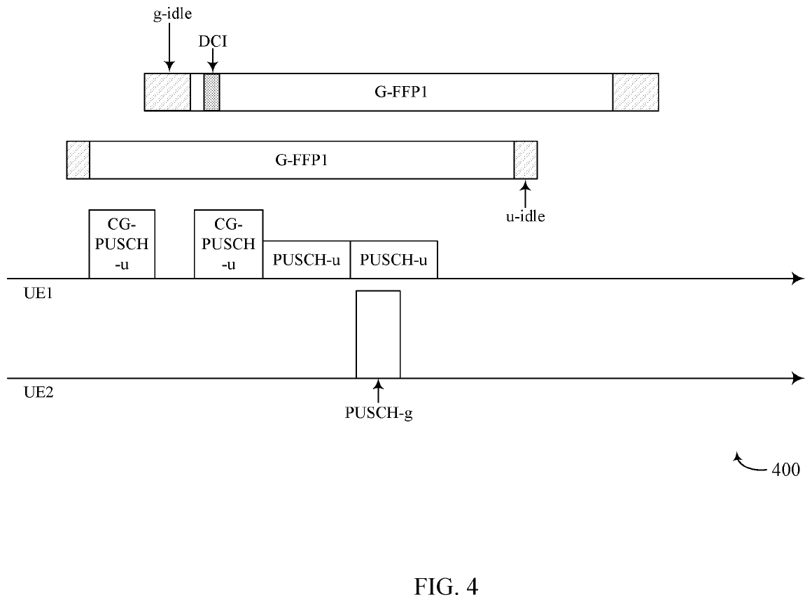

FIG. 4 illustrates an implementation 400 where a UE initiates a COT. For instance, at 400 a UE1 has already initiated a COT due to a first CG-PUSCH transmission, e.g., as CG-PUSCH aligned with a U-FFP1 boundary. A gNB knows there is a second CG-PUSCH coming up and would like to schedule UL transmission right after the second CG-PUSCH. The second CG-PUSCH is sent according to a UE-COT (e.g., based on an agreed UE behaviour for determining the COT initiator in case of CG transmissions), and a transmitting PUSCH-u according to UE-COT can avoid LBT prior to PUSCH-u transmission; whereas LBT maybe required if PUSCH-u is instead a PUSCH-g as it is to be transmitted assuming a g-COT. Further, the gNB wants to schedule a PUSCH for UE2. To enable the gNB to do this the PUSCH-g for UE1 is to be sent assuming a g-COT. An LBT/gap may be required between PUSCH-u and PUSCH-g of UE1.

Channel assess procedures based on semi-static channel occupancy as described in TS 37.213 are intended for environments where the absence of other technologies may be assumed, e.g., by level of regulations, private premises policies, etc. If a gNB provides UE(s) with higher layer parameters ChannelAccessMode-r16=‘semistatic’ by system information block (SIB)1 or dedicated configuration, a periodic channel occupancy can be initiated by the gNB every Tₓ within every two consecutive radio frames, starting from the even indexed radio frame at i·Tₓ x·Tₓ with a maximum channel occupancy time T_{y}=0.95Tₓ, where Tₓ=period T_{X}=Periodin ms, is a higher layer parameter provided in SemiStaticChannelAccessConfig and i ∈

$$\{ 0 , 1 , … , \frac{20}{{T}_{x}} - 1 \} .$$

In the procedures in this clause, when a gNB or UE performs sensing for evaluating a channel availability, the sensing can be performed at least during a sensing slot duration Tₛₗ=9 μs. The corresponding X_{Thresh} adjustment for performing sensing by a gNB or a UE is described in clauses 4.1.5 and 4.2.3, respectively.

A channel occupancy initiated by a gNB and shared with UE(s) is to satisfy the following:
The gNB is to transmit a downlink (DL) transmission burst starting at the beginning of the channel occupancy time immediately after sensing the channel to be idle for at least a sensing slot duration Tₛₗ=9 us. If the channel is sensed to be busy, the gNB is not to perform any transmission during the current period.
The gNB may transmit a DL transmission burst(s) within the channel occupancy time immediately after sensing the channel to be idle for at least a sensing slot duration Tₛₗ=9 us if the gap between the DL transmission burst(s) and any previous transmission burst is more than 16 us.
The gNB may transmit DL transmission burst(s) after UL transmission burst(s) within the channel occupancy time without sensing the channel if the gap between the DL and UL transmission bursts is at most 16 us.
A UE may transmit UL transmission burst(s) after detection of a DL transmission burst(s) within the channel occupancy time as follows:
   If the gap between the UL and DL transmission bursts is at most 16 us, the UE may transmit UL transmission burst(s) after a DL transmission burst(s) within the channel occupancy time without sensing the channel.
   If the gap between the UL and DL transmission bursts is more than 16 us, the UE may transmit UL transmission burst(s) after a DL transmission burst(s) within the channel occupancy time after sensing the channel to be idle for at least a sensing slot duration Tₛₗ=9 us within a 25 us interval ending immediately before transmission.
   The gNB and UEs are not to transmit any transmissions in a set of consecutive symbols for a duration of at least T_{z}=max(0.05Tₓ, 100 us) before the start of the next period.

If a UE fails to access the channel(s) prior to an intended UL transmission to a gNB, Layer 1 notifies higher layers about the channel access failure.

To improve on challenges presented in wireless channel configuration in some wireless communications systems, the present disclosure details solutions for channel configuration based on logical channel conditions. In the following discussion the term eNB and/or gNB is used to refer to a base station, but it is replaceable using any other radio access node, e.g., base station (BS), eNB, gNB, access point (AP), NR DU/CU, Relay, etc. Further, implementations are described primarily in the context of 5G NR. However, the described implementations are also equally applicable to other mobile communication systems supporting serving cells and carriers being configured in an unlicensed spectrum, e.g., LTE mobile wireless and/or cellular telecommunications systems. It should be noted that throughout the document the term “multi-PSSCH transmission” may refer to situations where a device has one or more SL grants that each schedule one or more SL resources, allocations, and/or transmissions resulting in SL transmissions in at least two SL (e.g., PSSCH and/or physical sidelink control channel (PSCCH)) resources. It should be further noted that one SL resource may comprise multiple transport blocks and/or PSSCH, e.g., for single user multiple input multiple output (SU-MIMO) transmissions. Further, one SL resource may correspond to one slot respectively partial slot or a mini-slot.

In implementations described herein a use case is considered where a UE may be implemented to perform a CCA procedure before being permitted to perform a set of multiple (e.g., consecutive) PSSCH and/or PSCCH transmissions. In such scenarios the proposed UE behaviors as disclosed in the various implementations are beneficial.

According to one or more implementations, a channel occupancy is initiated by a first UE and shared with one or more other UE(s) for sidelink transmissions in a shared spectrum. If there is a gap between the SL transmission bursts of the first UE and the other UEs which is more than a predefined gap duration (e.g. 16 us), the one or more other UEs may transmit SL transmission burst(s) after sensing the channel to be idle for at least a predefined sensing slot duration, e.g. Tₛₗ=9 us within a 25 us interval ending immediately before transmission.

In at least some implementations a UE doesn't map high priority data to the first x PSSCH resource(s) during a LCP procedure immediately following a CCA (e.g., LBT) procedure, which is for example the case for the first x PSSCH resource(s) of a channel occupancy for which the UE implemented the CCA procedure. Instead, high-priority data can be mapped to (x+1) and/or later resources.

A UE, for instance, is to ensure that when multiplexing the high priority data to a later PSSCH resource that a PSFCH group/timing is not delayed, e.g., PSFCH transmission is not moved to a later slot. A UE, for example, is only allowed to delay the multiplexing and/or transmission of high priority data to a later PSSCH resource if the PSFCH transmission timing is not affected. Otherwise, for example, the latency of the high priority data might be compromised due to a delayed HARQ feedback. The restriction/condition to not delay the PSFCH transmission timing may be according to one implementation dependent on the PSFCH periodicity. For example, for cases when the PSFCH periodicity is one (e.g., PSFCH resources are configured in every slot), it may not be possible to fulfil the condition of not delaying the PSFCH timing when high priority data is transmitted on a later PSSCH resource. Therefore it should be understood that this criterion may be only applicable for certain configurations, e.g., the criterion is only applied for certain PSFCH configurations.

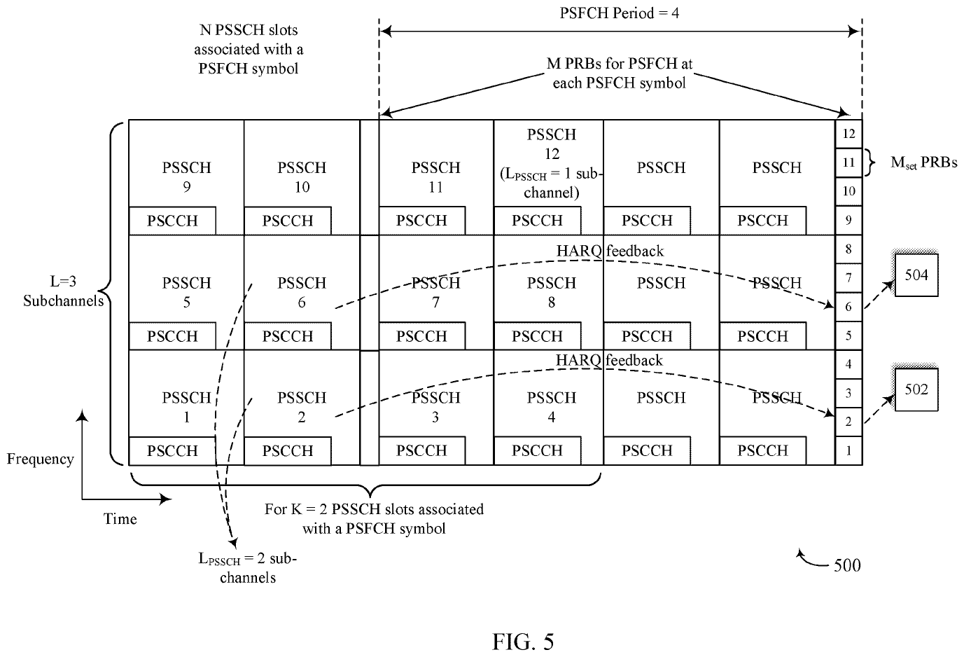

FIG. 5 illustrates an implementation 500 that supports channel configuration based on logical channel conditions in accordance with aspects of the present disclosure. The implementation 500, for instance, depicts PSFCH timing and resource handling (e.g., carrying HARQ feedback) for different PSSCH and PSCCH transmissions. As can be seen each PSSCH/PSCCH is associated with a PSFCH resource. According to various implementations for channel configuration based on logical channel conditions it is ensured that the PSFCH timing is not delayed and/or changed when multiplexing high priority data on a later PSSCH, e.g., not on a first PSSCH following a CCA.

In one example a UE considers logical channels (LCHs) having a logical channel priority that is lower than a configured threshold for the first x PSSCH/PSCCH resources immediately following a CCA during an LCP procedure. Thus, implementations can provide an LCH channel condition (e.g., rule) for the first x PSSCH/PSCCH resources. In at least some implementations, for the remaining PSSCH resources of the set of multiple PSSCH resources (e.g., x+1 PSSCH and following PSSCH resources) a UE can use legacy LCH restrictions rules, e.g., considering all LCHs regardless of their associated priority.

In the implementation 500 HARQ feedback from a PSSCH 2 is generated using a physical resource block (PRB) set 502, and HARQ feedback for a PSSCH 6 is generated using a PRB set 504.

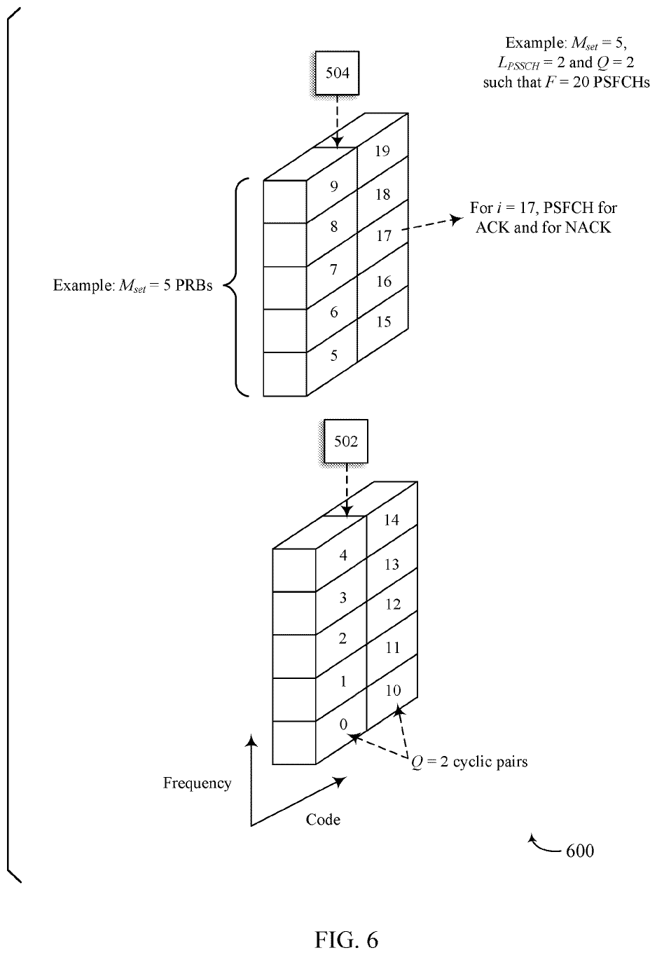

FIG. 6 illustrates an implementation 600 that supports channel configuration based on logical channel conditions in accordance with aspects of the present disclosure. The implementation 600 includes example implementations of the PRB sets 502, 504. As illustrated, the PRB sets 502, 504 each include 5 PRBs with 2 cyclic pairs for each PRB.

In at least some implementations, if a UE is granted and/or has selected two or more contiguous SL resources in time (e.g., whether as a result of multiple individual SL grants, multi-PSSCH grant(s), CG, or a combination of these), then for the first of such two SL resources the UE is to undergo CCA, while for the second SL resource no additional LBT may be necessary if the transmission in the preceding first SL resource was allowed and performed based on the CCA.

In at least some scenarios for a multi-PSSCH allocation, a first SL allocation has a highest probability of LBT failure. In one specific implementation of the embodiment x is equal to one, e.g., a UE doesn't map high priority data to the first SL resource and/or PSSCH allocation immediately following a CCA procedure, but instead maps high priority data to a second SL resource and/or PSSCH allocation following a CCA procedure. Consequently, a UE may use a different LCH restriction configuration for the first PSSCH resource when generating a TB compared to an LCP procedure performed for the second PSSCH resource.

According to at least one implementation, the UE:
uses a first LCH condition configuration for the generation of a TB/LCP procedure when the first x TB are mapped to the first x SL resource(s)/PSSCH allocation(s) during LCP procedure immediately following a CCA/LBT procedure, and
uses a second LCH condition configuration for the generation of a TB/LCP procedure when the TBs are not mapped to the first x SL resource(s)/PSSCH allocation(s) during LCP procedure immediately following a CCA/LBT procedure, i.e. mapped to the x+1 and following SL resources/PSSCH allocations.

According to at least one implementation, a UE doesn't multiplex MAC CE(s) to the first x SL resource allocation(s) immediately following a CCA procedure. Alternatively, the UE may be allowed to multiplex low-priority MAC CE(s) such as MAC CE for a recommended bit rate query and MAC CE for buffer state reporting (BSR) included for padding to the first x SL allocation(s) for cases when high priority data mapping is not performed by the UE.

According to at least one implementation, a UE is only allowed to multiplex high priority data (e.g., MAC CEs) to a later subsequent SL resource of a set of multiple SL resources (e.g., not a first ‘x’ PSSCH resources immediately following a CCA) if the associated acknowledgement/negative acknowledgement (ACK/NACK) timing on physical uplink control channel (PUCCH) is not impacted due to the delayed/postponed transmission of the high priority data and/or MAC CE(s). The UE, for instance, should still have sufficient processing time to generate and transmit the corresponding ACK/NACK on PUCCH to the gNB even though the PSFCH transmission associated with the high priority data may be delayed.

According to at least one implementation, a UE doesn't map high priority data to the first x PSSCH resource(s) during LCP procedure immediately following a CCA procedure, which is for example the case for the first x PSSCH resource(s) of a channel occupancy for which the UE underwent the CCA procedure. Instead, high-priority data can be mapped to the (x+1) and/or later SL resources. There are certain criteria which can be used to define whether a subsequent/later PSSCH/PSCCH is qualified for carrying the high priority data, e.g., whether a UE is allowed to delay the mapping/transmission of the high priority data to a particular PSSCH/PSCCH slot. According to at least one implementation, a UE does not multiplex the high priority data to a later PSSCH slot in case the MCS used for the later PSSCH/PSCCH slot is y levels higher compared to an MCS which UE would have used for the first PSSCH slot immediately following the CCA procedure. In one example y is a predefined threshold.

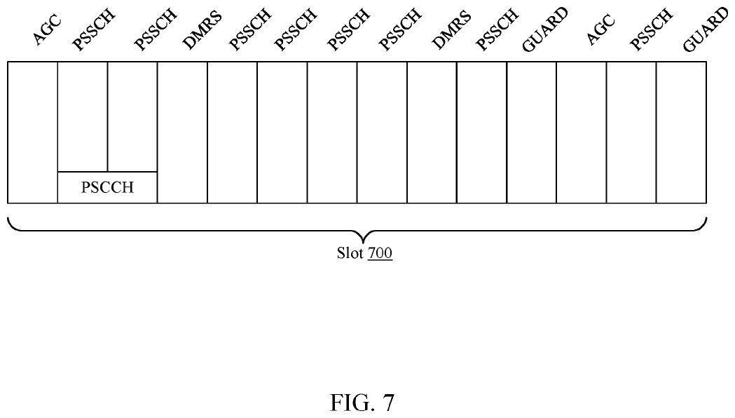

FIG. 7 illustrates an example of a slot 700 that supports channel configuration based on logical channel conditions in accordance with aspects of the present disclosure. In this particular example the slot 700 includes 14 sidelink symbols allocated for different purposes including automatic gain control (AGC), PSSCH, PSCCH, demodulation reference signal (DMRS), guard symbols, and PSFCH. In at least some implementations where high priority data is delayed certain adjustments may be made. For instance, consider that in the slot 700 high priority data is delayed from a PSSCH such that the data coincides with the PSFCH. In such scenarios an MCS may be modified (e.g., as described above) in order to account for the fewer symbols/PRBs used for the PSSCH transmission.

In at least some implementations a UE doesn't map high priority data to the first x PSSCH resource(s) during a LCP procedure immediately following a CCA procedure, but to a later, e.g. x+1, PSSCH resource in scenarios where the PSSCH/PSCCH resource does not contain a PSFCH. According to at least one implementation a UE does not multiplex the high priority data to a later PSSCH slot which contains a PSFCH. Further, in at least some implementations a UE may only map high-priority data to a later PSSCH/PSCCH slot which does not contain a PSFCH. Since PSSCH slots containing a PSFCH have less PSSCH symbols, the reliability of the TB containing the high priority data might be affected since the MCS might be higher compared to a slot with no PSFCH. The restriction/condition to not multiplex high priority data to PSSCH slot containing a PSFCH may be according to one implementation dependent on the PSFCH periodicity. For example, for cases when the PSFCH periodicity is one (e.g., PSFCH resources are configured in every slot), it may not be possible to fulfil such condition. Therefore, it should be understood that this criterion may be only applicable for certain configurations, e.g., the criterion is only applied for certain PSFCH configurations.

In at least some implementations a UE doesn't map high priority data to the first x PSSCH resource(s) during LCP procedure immediately following a CCA procedure, but to a later (e.g., x+1) PSSCH resource in scenarios where the PSSCH/PSCCH resource does not contain sidelink positioning reference symbols (SL-PRS). According to at least one implementation a UE is not permitted to multiplex high priority data to a PSSCH resource (e.g., a later resource) which is comprised of SL-PRS. For instance, a UE is only allowed to move and/or multiplex high-priority data (e.g., MAC CE(s)) to a later PSSCH/PSCCH slot which does not contain a SL-PRS.

In at least some implementations a UE is not permitted to delay the multiplexing/transmission of high priority data (e.g., MAC CE(s)) by more than a configured maximum delay. For instance, certain criteria are provided which define whether a subsequent PSSCH/PSCCH is qualified for carrying the high priority data, e.g., whether a UE is allowed to delay the mapping and/or transmission of the high priority data to this PSSCH/PSCCH slot. In at least one example a UE does not multiplex the high priority data to a later PSSCH slot which is more than n slots and/or t ms later than a first PSSCH/PSCCH slot immediately following a CCA procedure. In one example n and/or t correspond to respective predefined thresholds. In an additional or alternative example, a UE is to only multiplex high priority data to a later slot which still fulfills a latency bound (e.g., packet delay budget (PDB)) of the data, e.g., for Mode 2.

In at least some implementations a UE is not permitted to delay the multiplexing and/or transmission of high priority data (e.g., MAC CE(s)) to a PSSCH resource which is not in the DRX ActiveTime of a corresponding receiving UE. For instance, criteria can be provided which define whether a subsequent PSSCH/PSCCH is qualified for carrying high priority data, e.g., whether a UE is allowed to delay the mapping and/or transmission of the high priority data to a PSSCH/PSCCH slot. In at least one example a UE is only permitted to multiplex high priority data to a later PSSCH slot which is in the DRX ActiveTime of a selected destination, e.g., a receiving UE destination.

In at least some implementations a UE is not to map high priority data to the first PSSCH allocation immediately following a CCA procedure if the UE is aware that at least one more SL resource and/or PSSCH allocation is available for transmission immediately after the first such SL resource. For example, consider that a UE has SL grants for two SL transmissions in resource r1 and in resource r2, and the UE is to undergo an CCA procedure prior to transmitting in resource r1. Further, where a further LBT succeeds so that the UE can transmit in resource r1, and where resource r2 is not immediately following resource r1, the UE can apply the legacy LCH mapping/restriction behaviour during LCP procedure. If, however, resource r2 is immediately following resource r1 or with a gap up to a first predefined gap duration that is sufficiently short such that no new CCA procedure needs to be performed for the transmission in resource r2, then in at least some implementations the UE may not map high priority data for the transmission in resource r1. For instance, in this scenario the UE can decide autonomously based on its knowledge of whether CCA is required for transmission in resource r2 due to the gap whether to apply the described mapping behaviour, e.g., whether mapping higher priority data to a TB is to be applied or not.

In at least some implementations, a UE doesn't map high priority data to a first PSSCH allocation immediately following a CCA procedure if the UE has lower priority data (and/or other SL transmissions) to be transmitted in the first PSSCH allocation. In one example a UE is only allowed to move and/or multiplex high priority data to a later PSSCH resource in case the first p PSSCH transmissions and/or TBs for a first x PSSCH resources don't contain padding.

In at least some implementations a UE doesn't map high priority data to the first PSSCH allocation immediately following a CCA procedure if a first PSSCH allocation consists of a number of symbols that is smaller than a threshold. In an example, the threshold is signaled via higher layers and/or physical layer, and/or depends on a UE processing such as processing capability 1 or 2 defined in TS 38.214.

In at least some implementations a UE doesn't map high priority data to the first PSSCH allocation immediately following a CCA procedure if a first PSSCH allocation consists of a number of symbols that is larger than a threshold. In an example, the threshold is large enough to accommodate multiple non-overlapping CCAs or large enough that at least two CCAs can be performed such that a CCA failure event for them can be assumed with a high probability to be independent.

In at least some implementations a UE is configured whether it is allowed to apply different LCP restriction configurations (e.g., mapping of high priority data of LCH(s) and/or MAC CE(s) to PSSCH resources) for SL transmissions immediately following a CCA procedure. Such configuration may be done by higher layer signalling such as RRC signalling. In at least one example a UE may be allowed to move and/or multiplex high priority data to a later PSSCH resources only for specific cast types. For example, a UE is allowed to multiplex high priority data on a later PSSCH resource only for unicast traffic.

In at least some implementations a UE is only allowed to move and/or multiplex high priority data (e.g., MAC CE(s)) to a later PSSCH resource which has a same DMRS configuration as the UE would have used for the original PSSCH/PSCCH slot, e.g., a first SL resource immediately following a CCA procedure. For instance, the UE uses in the later PSSCH/PSCCH slot for the high priority data the same DMRS configuration as UE would have used for the original PSSCH/PSCCH slot, e.g., a first SL resource immediately following the CCA procedure.

The various implementations described herein can be applicable for scenarios where a UE has multiple (e.g., consecutive) SL resources and has already generated a TB for transmission on a PSSCH resource (e.g., a first of multiple PSSCH resources) and CCA fails for a corresponding transmission attempt. In such scenarios a UE can move the already generated TB to a HARQ process which is associated with a subsequent PSSCH resource fulfilling conditions described above. Examples of the condition include that a PSSCH resource contains no PSFCH and/or a PSSCH is selected such that PSFCH timing is not delayed. Subject to such conditions a UE can perform a transmission attempt on a later PSSCH resource. This can ensure that high priority data is not delayed by CCA failure such as may occur when the high priority data is multiplexed on the first x PSSCH resources of multiple PSSCH resources.

In at least some implementations a UE can trigger a selection (e.g., a new selection and/or reselection) of a new SL resource for scenarios when a SL transmission was not performed due to an LBT failure. In at least one implementation, for instance, a UE which is configured for autonomous resource allocation mode (e.g., Mode 2) selects a new SL resource for the transmission of a TB in response to receiving an LBT failure indication from a PHY layer for a transmission attempt of the TB and/or PSSCH. An LBT failure event, for example, represents a new trigger for SL resource (re)selection. For instance, in contrast with operation on unlicensed spectrum for the NR Uu interface, a UE is allowed to immediately (e.g., in a next slot, no needed delay) retransmit a TB which is pending in the HARQ buffer. For example, no timer is applied (e.g., a CG retransmission timer (CGRT) timer) which defines when a UE is allowed to autonomously retransmit a TB in the pending HARQ process. In at least one example the UE has selected a SL resource for an initial transmission of a TB and two HARQ retransmissions, e.g., blind HARQ retransmissions are used.

For instance, in scenarios where an initial transmission cannot take place due to an LBT failure, a UE can autonomously select an additional SL resource to make an autonomous retransmission of the initial transmission. The UE, for example, selects SL resources which are occurring before the original first HARQ retransmission. The UE can ensure that a PDB is still fulfilled even though the initial transmission of the TB is postponed due to an LBT failure. In at least some implementations a UE is to only select a SL resource for an autonomous retransmission which fulfils certain criteria as described in the above implementations, e.g., a selected PSSCH resource is not to contain a PSFCH or SL-PRS.

In at least some implementations a UE is permitted to make an additional transmission attempt in case of LBT failure for a HARQ (re)transmission, e.g., autonomous retransmission is supported for a HARQ (re)transmission. For instance, a UE is not required to consider a minimum time gap between SL resources selected for an original transmission attempt of a TB and the additional SL resource selected as triggered by the LBT failure. In at least one example the UE selects the additional SL resource such that a PSFCH if configured for a resource pool can still be transmitted by a receiving UE from processing delay perspective.

In at least some implementations a UE is permitted to go beyond the allowed number of HARQ transmissions (e.g., such as configured by RRC such as in sl-MaxTxTransNumPSSCH) for scenarios where a HARQ transmission could not take place due to an LBT failure if the PDB associated with a TB is still fulfilled. For instance, a parameter sl-MaxTxTransNumPSSCH configures a maximum number of HARQ transmissions which a UE is allowed to perform, not the maximum number of HARQ transmission attempts and/or transmission opportunities.

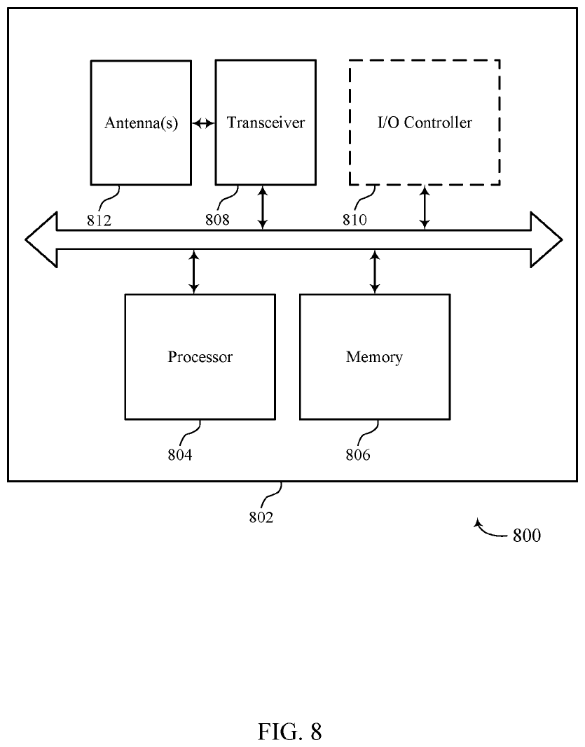

FIG. 8 illustrates an example of a block diagram 800 of a device 802 (e.g., an apparatus) that supports channel configuration based on logical channel conditions in accordance with aspects of the present disclosure. The device 802 may be an example of UE 104 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the 806, the transceiver 808, or various combinations thereof or various components thereof may be examples of means for performing various aspects of the present disclosure as described herein. For example, the processor 804, the 806, the transceiver 808, or various combinations or components thereof may support a method for performing one or more of the operations described herein.

In some implementations, the processor 804, the 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the 806 coupled with the processor 804 may be configured to perform one or more of the functions described herein (e.g., executing, by the processor 804, instructions stored in the 806). In the context of UE 104, for example, the transceiver 808 and the processor coupled 804 coupled to the transceiver 808 are configured to cause the UE 104 to perform the various described operations and/or combinations thereof.

For example, the processor 804 and/or the transceiver 808 may support wireless communication at the device 802 in accordance with examples as disclosed herein. For instance, the processor 804 and/or the transceiver 808 may be configured as or otherwise support a means to generate, for a set of PSSCH allocations and based at least in part on a first logical channel condition associated with logical channel prioritization, a first set of MAC PDUs for a first subset of PSSCH allocations of the set of PSSCH allocations; and generate, for the set of PSSCH allocations and based at least in part on a second logical channel condition associated with logical channel prioritization, a second set of MAC PDUs for a second subset of PSSCH allocations of the set of PSSCH allocations.

Further, in some implementations, the processor 804 and/or the transceiver 808 may be configured as or otherwise support a means to determine the set of PSSCH allocations based on at least one predefined criterion; where the at least one predefined criterion includes that the second subset of PSSCH allocations do not include a PSFCH; where the at least one predefined criterion includes that the second subset of PSSCH allocations do not include a sidelink PRS; where the first subset of PSSCH allocations starts with a first PSSCH allocation of the set of PSSCH allocations; to perform a listen before talk procedure before the first subset of PSSCH allocations; to prevent, as part of the logical channel prioritization, mapping of high priority data to the first subset of PSSCH allocations; where the first logical channel condition is different than the second logical channel condition; where the set of PSSCH allocations includes consecutive PSSCH allocations.

Further, in some implementations, the first logical channel condition includes that data below a threshold priority is mapped to the first subset of PSSCH allocations; where the first logical channel condition includes that data above a threshold priority is not mapped to the first subset of PSSCH allocations; where the second logical channel condition includes an indication that data above a threshold priority is mapped to the second subset of PSSCH allocations; where the second logical channel condition includes that when data above a threshold priority is mapped to a PSSCH resource of the second subset of PSSCH allocations, one or more of: the PSSCH resource does not include a PSFCH; PSFCH timing is not delayed; the PSSCH resource does not include sidelink PRS; the PSSCH resource is within a DRX time of a transmit destination UE; or a MSC to be used for transmission over the PSSCH resource is not a specified level higher than an MCS previously selected for the PSSCH resource; means are supported to transmit data over one or more of the first set of MAC PDUs or the second set of MAC PDUs; means are supported to transmit data over one or more of the first subset of PSSCH allocations or the second subset of PSSCH allocations.

In a further example, the processor 804 and/or the transceiver 808 may support wireless communication at the device 802 in accordance with examples as disclosed herein. The processor 804 and/or the transceiver 808, for instance, may be configured as or otherwise support a means to perform a listen before talk procedure on a first sidelink resource to be used for a sidelink transmission; select, autonomously by the UE and based at least in part on a failure of the listen before talk procedure, a second sidelink resource to be used for the sidelink transmission; and transmit the sidelink transmission using the second sidelink resource.

Further, in some implementations, the processor 804 and/or the transceiver 808 may be configured as or otherwise support a means to receive an indication of the failure of the listen before talk procedure from a PHY layer; where the second sidelink resource includes a next slot after the first sidelink resource; select the second sidelink resource as a sidelink resource such that one or more of: the second sidelink resource does not include a PSFCH; PSFCH timing is not delayed by selection of the second sidelink resource; the second sidelink resource does not include sidelink PRS; the second sidelink resource is within a DRX time of a transmit destination UE; or a MSC to be used for transmission over the second sidelink resource is not a specified level higher than an MCS previously selected for the first sidelink resource; where the sidelink transmission on the first sidelink resource includes a transport block in a HARQ buffer, and where to transmit the sidelink transmission using the second sidelink resource includes a HARQ retransmission of the transport block; where the UE is configured with a maximum number of HARQ transmissions, and the UE is configured to exceed the maximum number with the HARQ retransmission of the transport block.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the 806) to cause the device 802 to perform various functions of the present disclosure.

The 806 may include random access memory (RAM) and read-only memory (ROM). The 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor M08. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

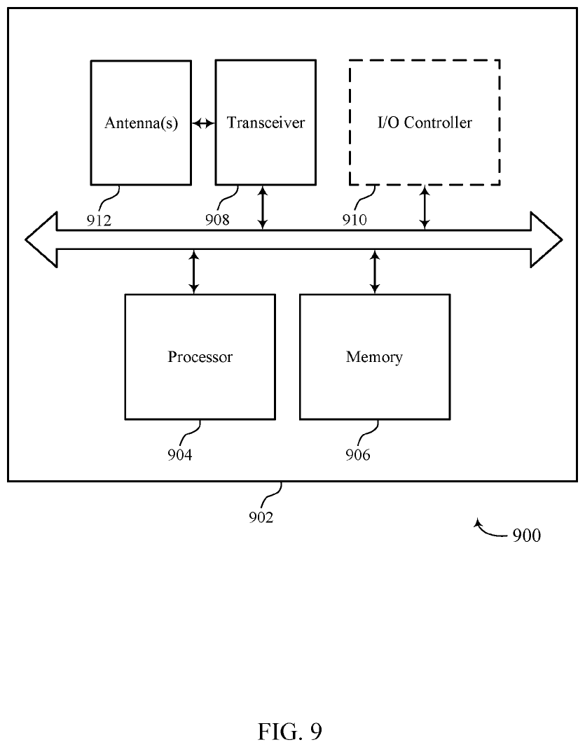

FIG. 9 illustrates an example of a block diagram 900 of a device 902 (e.g., an apparatus) that supports channel configuration based on logical channel conditions in accordance with aspects of the present disclosure. The device 902 may be an example of a network entity 102 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906). In the context of network entity 102, for example, the transceiver 908 and the processor 904 coupled to the transceiver 908 are configured to cause the network entity 102 to perform the various described operations and/or combinations thereof.

For example, the processor 904 and/or the transceiver 908 may support wireless communication at the device 902 in accordance with examples as disclosed herein. For instance, the processor 904 and/or the transceiver 908 may be configured as or otherwise support a means to generate a notification that specifies, for a set of PSSCH allocations: a first logical channel condition associated with logical channel prioritization for a first subset of PSSCH allocations of the set of PSSCH allocations; and a second logical channel condition associated with logical channel prioritization for a second subset of PSSCH allocations of the set of PSSCH allocations; and transmit the notification to a UE.

Further, in some implementations, the notification specifies that the first subset of PSSCH allocations is to start with a first PSSCH allocation of the set of PSSCH allocations; where the first logical channel condition is different than the second logical channel condition; where the first logical channel condition specifies that high priority data is not to be mapped to the first subset of PSSCH allocations; where the second logical channel condition includes an indication that data above a threshold priority is to be mapped to the second subset of PSSCH allocations; where the second logical channel condition includes that when data above a threshold priority is mapped to a PSSCH resource of the second subset of PSSCH allocations, one or more of: the PSSCH resource is not to include a PSFCH; PSFCH timing is not to be delayed; the PSSCH resource is not to include sidelink PRS; the PSSCH resource is to be within a DRX time of a transmit destination UE; or a MSC to be used for transmission over the PSSCH resource is not to be a specified level higher than an MCS previously selected for the PSSCH resource.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor M06. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

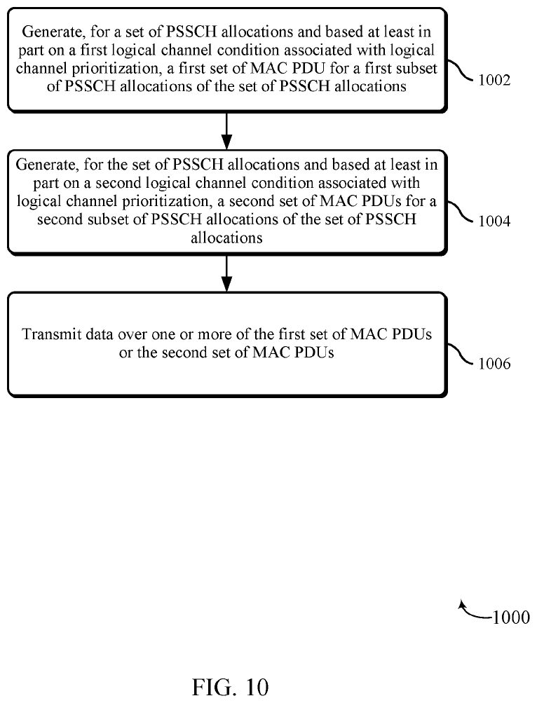

FIG. 10 illustrates a flowchart of a method 1000 that supports channel configuration based on logical channel conditions in accordance with aspects of the present disclosure. The operations of the method 1000 may be implemented by a device or its components as described herein. For example, the operations of the method 1000 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1002, the method may include generating, for a set of PSSCH allocations and based at least in part on a first logical channel condition associated with logical channel prioritization, a first set of MAC PDU for a first subset of PSSCH allocations of the set of PSSCH allocations. The operations of 1002 may be performed in accordance with examples as described herein. In some implementations, aspects of the operations of 1002 may be performed by a device as described with reference to FIG. 1.

At 1004, the method may include generating, for the set of PSSCH allocations and based at least in part on a second logical channel condition associated with logical channel prioritization, a second set of MAC PDUs for a second subset of PSSCH allocations of the set of PSSCH allocations. The operations of 1004 may be performed in accordance with examples as described herein. In some implementations, aspects of the operations of 1004 may be performed by a device as described with reference to FIG. 1.

At 1006, the method may include transmitting data over one or more of the first set of MAC PDUs or the second set of MAC PDUs. The operations of 1006 may be performed in accordance with examples as described herein. In some implementations, aspects of the operations of 1006 may be performed by a device as described with reference to FIG. 1.

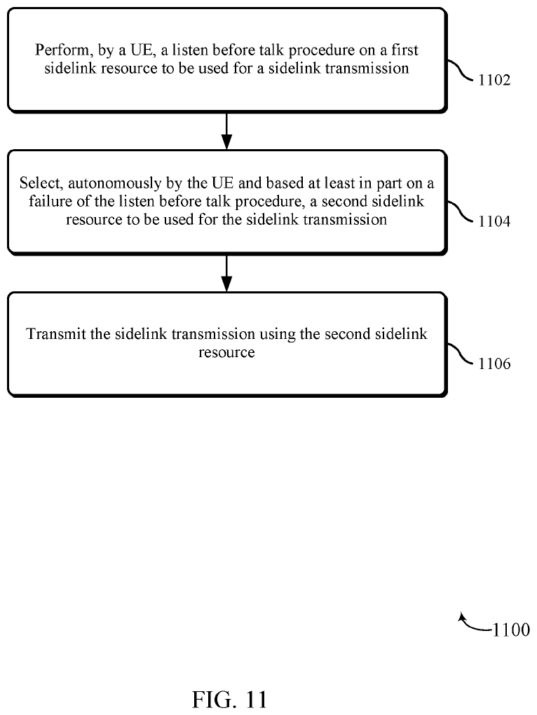

FIG. 11 illustrates a flowchart of a method 1100 that supports channel configuration based on logical channel conditions in accordance with aspects of the present disclosure. The operations of the method 1100 may be implemented by a device or its components as described herein. For example, the operations of the method 1100 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1102, the method may include performing, by a UE, a listen before talk procedure on a first sidelink resource to be used for a sidelink transmission. The operations of 1102 may be performed in accordance with examples as described herein. In some implementations, aspects of the operations of 1102 may be performed by a device as described with reference to FIG. 1.

At 1104, the method may include selecting, autonomously by the UE and based at least in part on a failure of the listen before talk procedure, a second sidelink resource to be used for the sidelink transmission. The operations of 1104 may be performed in accordance with examples as described herein. In some implementations, aspects of the operations of 1104 may be performed by a device as described with reference to FIG. 1.

At 1106, the method may include transmitting the sidelink transmission using the second sidelink resource. The operations of 1106 may be performed in accordance with examples as described herein. In some implementations, aspects of the operations of 1106 may be performed by a device as described with reference to FIG. 1.

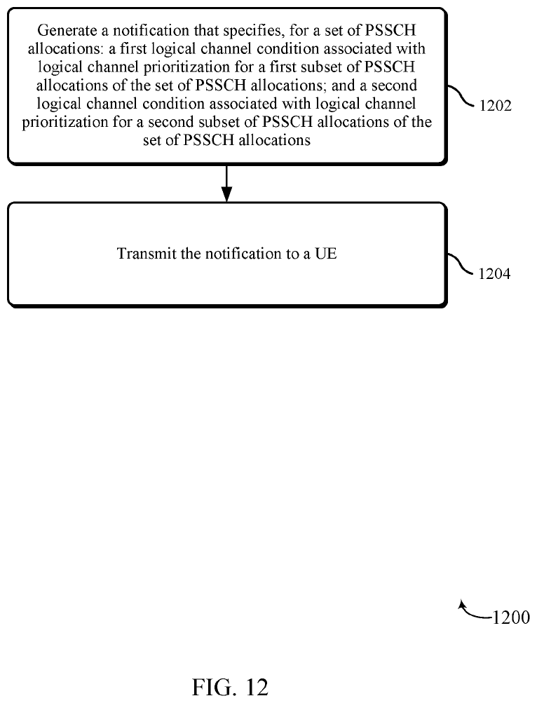

FIG. 12 illustrates a flowchart of a method 1200 that supports channel configuration based on logical channel conditions in accordance with aspects of the present disclosure. The operations of the method 1200 may be implemented by a device or its components as described herein. For example, the operations of the method 1200 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1202, the method may include generating a notification that specifies, for a set of PSSCH allocations: a first logical channel condition associated with logical channel prioritization for a first subset of PSSCH allocations of the set of PSSCH allocations; and a second logical channel condition associated with logical channel prioritization for a second subset of PSSCH allocations of the set of PSSCH allocations. The operations of 1202 may be performed in accordance with examples as described herein. In some implementations, aspects of the operations of 1202 may be performed by a device as described with reference to FIG. 1.

At 1204, the method may include transmitting the notification to a UE. The operations of 1204 may be performed in accordance with examples as described herein. In some implementations, aspects of the operations of 1204 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1-20. (canceled)

21. A user equipment (UE) for wireless communication, comprising:
at least one memory; and
at least one processor coupled with the at least one memory and configured to cause the UE to:
select, autonomously by the UE and based at least in part on a failure of a listen before talk procedure on a first set of sidelink resources from a first sidelink grant, a second set of sidelink resources to be used for a sidelink transmission; and
perform a transmission attempt using the second set of sidelink resources.

22. The UE of claim 21, wherein an indication of the failure of the listen before talk procedure on the first set of sidelink resources is received from a lower layer.

23. The UE of claim 22, wherein the lower layer comprises a physical (PHY) layer.

24. The UE of claim 21, wherein the transmission attempt using the second set of sidelink resources comprises a hybrid automatic repeat-request (HARQ) retransmission of a transport block.

25. The UE of claim 21, wherein the UE is configured with sidelink resource allocation mode 2.

26. The UE of claim 21, wherein a resource reselection is triggered based at least in part on an indication of the failure of the listen before talk procedure for the first sidelink grant.

27. The UE of claim 21, wherein a second sidelink grant is selected to include the second set of sidelink resources based at least in part on an indication of the failure of the listen before talk procedure for the first sidelink grant.

28. The UE of claim 21, wherein one or more of:
the second set of sidelink resources does not include a physical sidelink feedback channel (PSFCH);
PSFCH timing is not delayed by selection of the second set of sidelink resources;
the second set of sidelink resources does not include sidelink positioning reference signal (PRS);
the second set of sidelink resources is within a discontinuous reception (DRX) time of a transmit destination UE; or
a modulation and coding scheme (MCS) to be used for the transmission attempt over the second set of sidelink resources is not a specified level higher than an MCS previously selected for the first set of sidelink resources.

29. A processor for wireless communication, comprising:
at least one controller coupled with at least one memory and configured to cause the processor to:
select, autonomously by a user equipment (UE) and based at least in part on a failure of a listen before talk procedure on a first set of sidelink resources from a first sidelink grant, a second set of sidelink resources to be used for a sidelink transmission; and
perform a transmission attempt using the second set of sidelink resources.

30. The processor of claim 29, wherein an indication of the failure of the listen before talk procedure on the first set of sidelink resources is received from a lower layer.

31. The processor of claim 30, wherein the lower layer comprises a physical (PHY) layer.

32. The processor of claim 29, wherein the transmission attempt using the second set of sidelink resources comprises a hybrid automatic repeat-request (HARQ) retransmission of a transport block.

33. The processor of claim 29, wherein the processor is configured with sidelink resource allocation mode 2.

34. The processor of claim 29, wherein a resource reselection is triggered based at least in part on an indication of the failure of the listen before talk procedure for the first sidelink grant.

35. The processor of claim 29, wherein a second sidelink grant is selected to include the second set of sidelink resources based at least in part on an indication of the failure of the listen before talk procedure for the first sidelink grant.

36. The processor of claim 29, wherein one or more of:
the second set of sidelink resources does not include a physical sidelink feedback channel (PSFCH);
PSFCH timing is not delayed by selection of the second set of sidelink resources;
the second set of sidelink resources does not include sidelink positioning reference signal (PRS);
the second set of sidelink resources is within a discontinuous reception (DRX) time of a transmit destination UE; or
a modulation and coding scheme (MCS) to be used for the transmission attempt over the second set of sidelink resources is not a specified level higher than an MCS previously selected for the first set of sidelink resources.

37. A method performed by a user equipment (UE), the method comprising:
selecting, autonomously by the UE and based at least in part on a failure of a listen before talk procedure on a first set of sidelink resources from a first sidelink grant, a second set of sidelink resources to be used for a sidelink transmission; and
performing a transmission attempt using the second set of sidelink resources.

38. The method of claim 37, wherein an indication of the failure of the listen before talk procedure on the first set of sidelink resources is received from a lower layer.

39. The method of claim 38, wherein the lower layer comprises a physical (PHY) layer.

40. A user equipment (UE) for wireless communication, comprising:
at least one memory; and
at least one processor coupled with the at least one memory and configured to cause the UE to:
generate, for a set of physical sidelink shared channel (PSSCH) allocations and based at least in part on a first logical channel condition associated with logical channel prioritization, a first set of media access control (MAC) protocol data units (PDU) for a first subset of PSSCH allocations of the set of PSSCH allocations; and
generate, for the set of PSSCH allocations and based at least in part on a second logical channel condition associated with logical channel prioritization, a second set of MAC PDUs for a second subset of PSSCH allocations of the set of PSSCH allocations.
